(19) United States
(12) Patent Application Publication
(10) Pub. No.: US 2026/0221626 A1
(43) Pub. Date: Jul. 30, 2026

(54) ELECTRICITY STORAGE DEVICE AND METHOD FOR MANUFACTURING THE SAME

(71) Applicant: Prime Planet Energy & Solutions, Inc., Tokyo (JP)

(72) Inventor: Kohei YAMADA, Kobe-shi (JP)

(21) Appl. No.: 19/460,320

(22) Filed: Jan. 27, 2026

(30) Foreign Application Priority Data
Jan. 30, 2025 (JP) 2025-013540

(51) Int. Cl. H01M 50/566; H01M 50/103; H01M 50/528; H01M 50/533; H01M 50/553; H01M 50/567

(52) U.S. Cl. CPC H01M 50/566; H01M 50/528; H01M 50/533; H01M 50/553; H01M 50/567; H01M 50/103

(57) ABSTRACT

Provided is a technology for further enhancing the quality of welding between a first and a second electrically conductive members. An energy storage device disclosed herein comprises a first and a second electrically conductive members. A connection portion of the second electrically conductive member is inserted into a through hole of the first electrically conductive member. A riveted portion of the second electrically conductive member is provided at the end of the connection portion, and riveted onto the edge of the through hole. The riveted portion has a welded portion of the first and the second electrically conductive members. A gap is provided between the first and the second electrically conductive members in the inner side relative to the welded portion. The welded portion comprises a first welded area and a second welded area having a weld depth smaller than that of the first welded area.

### CROSS REFERENCE TO RELATED APPLICATION

The present application claims the priority based on Japanese Patent Application No. 2025-013540 filed on Jan. 30, 2025, the entire contents of which are incorporated in the present specification by reference.

### BACKGROUND OF THE DISCLOSURE

### 1. Field

The present disclosure relates to an energy storage device and a method for manufacturing the energy storage device.

### 2. Background

Japanese Patent Application Publication No. 2017-10743 discloses a secondary battery comprising an electrode assembly, an exterior casing, a sealing plate having a terminal mounting hole, a current collector, and a terminal inserted into the terminal mounting hole. The current collector has a through hole. A countersunk hole is formed around the through hole. The terminal is inserted into the through hole, and riveted at its tip side inside the countersunk hole. The tip of the riveted portion of the terminal is welded to the current collector. In the current collector, a groove portion is provided at the peripheral side of the countersunk hole. The publication describes that this configuration can further improve the quality of a welded portion between the tip of the riveted portion of the terminal and the current collector, thereby further enhancing reliability.

Japanese Patent Application Publication No. 2022-28968 discloses a secondary battery comprising an electrode assembly, an exterior casing, a sealing plate having a terminal insertion hole, a terminal penetrating the terminal insertion hole, and a current collector having a terminal connection hole. The terminal is arranged inside the terminal connection hole. The terminal connection hole has a first hole portion and a second hole portion connected to the first hole portion. The first hole portion is provided in the side of the electrode assembly relative to the second hole portion. The first hole portion has an inner dimension larger than that of the second hole portion. The terminal has a riveted portion having an outer diameter larger than the inner diameter of a portion having the smallest inner diameter in the terminal connection hole. The riveted portion and the current collector are joined via a solidified portion formed when at least one of the riveted portion and the current collector melts and solidifies. A recessed portion is formed at the solidified portion. In the thickness direction of the current collector, the bottom of the recessed portion is located in the side of the electrode assembly relative to the second hole portion. The publication describes that this configuration can enhance the reliability of the secondary battery.

Japanese Patent Application Publication No. 2019-125491 discloses a method of manufacturing a secondary battery. The resulting secondary battery comprises an electrode assembly, an exterior casing, a sealing plate having a terminal insertion hole, a terminal penetrating the terminal insertion hole, and a current collector having a terminal connection hole. In a configuration where the terminal is not yet welded to the current collector, the terminal connection hole has a tapered portion having an inner diameter gradually increasing toward the side of one end. This manufacturing method comprises: an insertion step of inserting the terminal into the terminal connection hole; a riveting step of riveting the terminal onto the tapered portion to form a riveted portion on the terminal; and a welding step of irradiating at least one of the riveted portion of the terminal and the tapered portion of the current collector with an energy beam to weld the terminal to the current collector. At the riveting step, the terminal is riveted so that a gap is created between the riveted portion and the tapered portion. At the welding step, at least one of the terminal and the current collector is melted by irradiation with an energy beam so that molten metal constituting at least one of the terminal and the current collector flows into the gap, thereby forming a recessed portion at a solidified portion where the molten metal solidifies. The publication describes that this configuration can enhance the reliability of a secondary battery.

### SUMMARY

An energy storage device comprises, for example, an electrode assembly, a first electrically conductive member electrically connected to a positive electrode or a negative electrode of the electrode assembly, and a second electrically conductive member electrically connected to the first electrically conductive member. Here, the first electrically conductive member and the second electrically conductive member may be joined by welding. The present inventor tries to further improve the quality of welding between the first electrically conductive member and the second electrically conductive member.

According to the technology disclosed herein, an energy storage device is provided. The energy storage device comprises an electrode assembly including a positive electrode and a negative electrode, a first electrically conductive member electrically connected to the positive electrode or the negative electrode, and a second electrically conductive member electrically connected to the first electrically conductive member. The first electrically conductive member comprises a through hole. The second electrically conductive member comprises a connection portion and a riveted portion. The connection portion is inserted into the through hole. The riveted portion is provided at the end of the connection portion, and riveted onto the edge of the through hole of the first electrically conductive member. The riveted portion has a welded portion where the first electrically conductive member and the second electrically conductive member are welded together. A gap is provided between the first electrically conductive member and the second electrically conductive member in the inner side relative to the welded portion. The welded portion provided at the riveted portion comprises a first welded area and a second welded area having a weld depth smaller than that of the first welded area. According to the configuration, the quality of welding between the first electrically conductive member and the second electrically conductive member can be further enhanced.

According to the technology disclosed herein, a method of manufacturing an energy storage device is provided. The manufacturing method comprises a preparation step, an insertion step, a riveting step, and a welding step. At the preparation step, provided is a first electrically conductive member having a through hole, which is to be electrically connected to a positive electrode of an electrode assembly, and a second electrically conductive member having a connection portion, which is to be electrically connected to the first electrically conductive member. At the insertion step, the connection portion of the second electrically conductive member is inserted into the through hole of the first electrically conductive member. At the riveting step, the end of the connection portion is riveted onto the edge of the through hole of the first electrically conductive member to form a riveted portion. At the welding step, the riveted portion and the first electrically conductive member are welded by irradiation with an energy beam. At the welding step, the irradiation with the energy beam is applied under the condition that a gap is present between the first electrically conductive member and the second electrically conductive member in the inner side relative to a portion which is irradiated with the energy beam. The welding step comprises a first welding step and a second welding step. At the first welding step, a first region is irradiated with an energy beam to form a first welded area. At the second welding step, a second region is irradiated with an energy beam to form a second welded area having a weld depth smaller than that of the first welded area. According to the configuration, the quality of welding between the first electrically conductive member and the second electrically conductive member can be further enhanced.

### BRIEF DESCRIPTION OF THE DRAWINGS

FIG. 1 shows a schematic perspective view of an energy storage device 1;

FIG. 2 shows a cross-sectional view along the line II-II in FIG. 1;

FIG. 3 shows a schematic perspective view of a sealing plate 14 and an electrode assembly 20;

FIG. 4 shows a schematic perspective view of a second current collector member 52 and the electrode assembly 20;

FIG. 5 shows a schematic diagram of the electrode assembly 20;

FIG. 6 shows a partially enlarged cross-sectional view of the vicinity of a positive electrode terminal 30 shown in FIG. 2;

FIG. 7 shows a partially enlarged view of FIG. 6;

FIG. 8 shows a plan view of the vicinity of a riveted portion 30b;

FIG. 9 shows a cross-sectional view of the vicinity of the riveted portion 30b;

FIG. 10 shows a plan view of the vicinity of the riveted portion 30b;

FIG. 11 shows a plan view of the vicinity of the riveted portion 30b; and

FIG. 12 shows a plan view of the vicinity of the riveted portion 30b.

### DESCRIPTION OF THE EMBODIMENTS

The embodiments of the energy storage device disclosed herein will be described below. The embodiments described herein are not intended to limit the scope of the technology disclosed herein. The technology disclosed herein is not limited to the embodiments described herein unless specifically stated. The drawings are depicted schematically and do not necessarily reflect the actual products. Members and portions showing the same effects may be assigned the same reference numbers as appropriate, and redundant descriptions may be omitted. The expression “A to B” showing a numerical range means “A or more and B or less” unless otherwise specified, and also encompasses the meaning of “above A and below B.”

As used herein, the term “energy storage device” refers to a device in which charging and discharging occur due to the movement of charge carriers between a pair of electrodes (positive electrode and negative electrode) through an electrolyte. The energy storage devices include secondary batteries such as lithium-ion secondary batteries; capacitors such as lithium-ion capacitors and electrical double layer capacitors. Below, the embodiments in which the energy storage device is a lithium-ion secondary battery will be described.

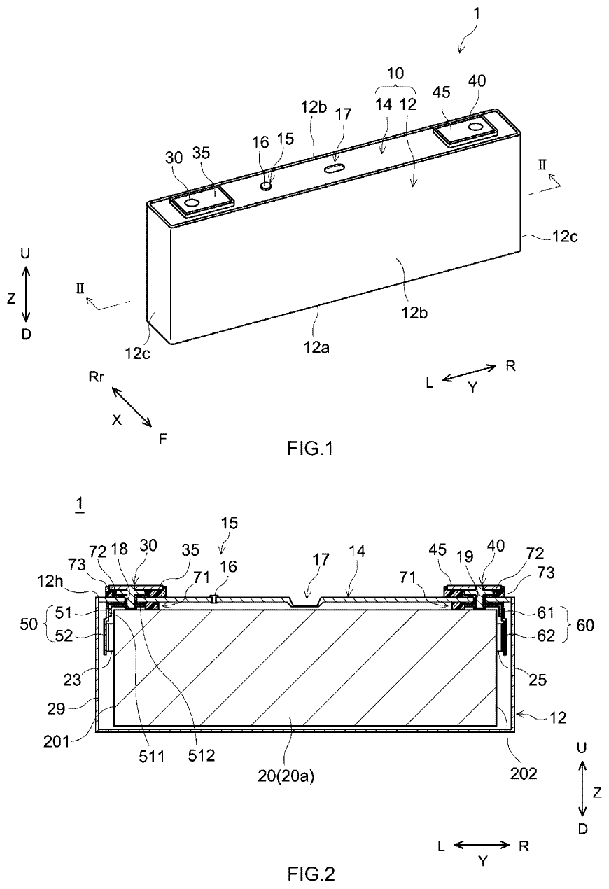

FIG. 1 shows a schematic perspective view of an energy storage device 1. FIG. 2 shows a cross-sectional view along the line II-II in FIG. 1. As shown in FIGS. 1 and 2, the energy storage device 1 comprises a case 10, an electrode assembly 20, a positive electrode terminal 30, a negative electrode terminal 40, external electrically conductive members 35, 45, a positive electrode current collector 50, a negative electrode current collector 60, various insulating members, and an electrolyte (not shown).

The case 10 is an exterior container for housing the electrode assembly 20 and a non-aqueous electrolyte. Here, the case 10 is a flattened cuboidal case. There is no particular limitation for the material of the case 10, and, for example, materials suitable for cases of this kind of energy storage device can be used appropriately.

As shown in FIGS. 1 and 2, the case 10 comprises an exterior casing 12 and a sealing plate 14. The exterior casing 12 has a bottom surface 12a, an opposing pair of first side surfaces 12b, and an opposing pair of second side surfaces 12c. The bottom surface 12a is rectangular in shape. As shown in FIG. 2, an opposite portion to the bottom surface 12a corresponds to an opening 12h. The opposing pair of the first side surfaces 12b are rectangular in shape and extend from an opposing pair of long sides of the bottom surface 12a. The opposing pair of the second side surfaces 12c are rectangular in shape and extend from an opposing pair of short sides of the bottom surface 12a. In this embodiment, the area of the opposing pair of the first side surfaces 12b is larger than the area of the opposing pair of the second side surfaces 12c.

As shown in FIGS. 1 and 2, the sealing plate 14 is a rectangular flat plate and has a shape corresponding to the opening 12h. The sealing plate 14 here has an injection hole 15, a safety valve 17, and terminal mounting holes 18 and 19. The injection hole 15 is a portion through which a non-aqueous electrolyte is injected into the case 10. As shown in FIGS. 1 and 2, the injection hole 15 is sealed with a sealing member 16. The safety valve 17 is, for example, a thin-walled portion designed to release the internal pressure of the case 10 when it increases to a predetermined level or above. The terminal mounting holes 18 and 19 are through holes into which the positive electrode terminal 30 or the negative electrode terminal 40 is attached. The sealing plate 14 closes the opening 12h and is welded (e.g., laser welded) to the exterior casing 12.

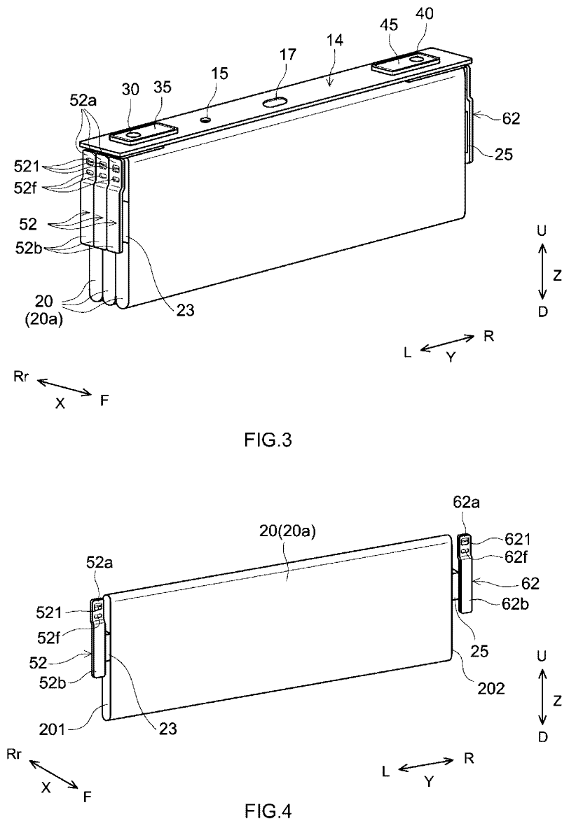

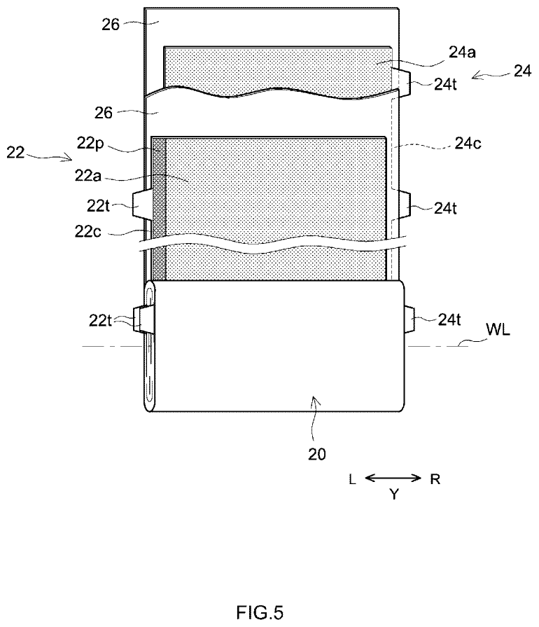

FIG. 3 shows a schematic perspective view of the sealing plate 14 and the electrode assembly 20. FIG. 3 schematically shows the electrode assembly 20 having the sealing plate 14 attached. FIG. 4 shows a schematic perspective view of a second current collector member 52 and the electrode assembly 20. FIG. 4 schematically shows the electrode assembly 20 having the second current collector member 52 attached. As shown in FIG. 3, the energy storage device 1 comprises 3 electrode assemblies 20. As shown in FIGS. 3 and 4, in the electrode assembly 20, the second current collector member 52 of the positive electrode current collector 50 is attached to one side (the left side in FIGS. 3 and 4) in the long-side direction Y, and the second current collector member 62 of the negative electrode current collector 60 is attached to the other side (the right side in FIGS. 3 and 4) in the long-side direction Y. As shown in FIG. 2, the electrode assembly 20 is placed inside the exterior casing 12, and covered by an electrode assembly holder 29 made of a resin sheet such as polypropylene (PP). It is noted that there is no particular limitation for the number of electrode assemblies 20 in the energy storage device 1, and it may be, for example, 1, 2, or 4 or more.

FIG. 5 shows a schematic diagram of the electrode assembly 20. As shown in FIG. 5, the electrode assembly 20 comprises a positive electrode 22, a negative electrode 24, and a separator 26. The electrode assembly 20 is a wound electrode assembly formed by laminating a long sheet-shaped positive electrode 22 and a long sheet-shaped negative electrode 24 with a long sheet-shaped separator 26 interposed between them, and then winding them in the longitudinal direction. As shown in FIGS. 2 to 4, the electrode assembly 20 comprises a body 20a, a positive electrode tab group 23, and a negative electrode tab group 25. The body 20a is a portion where the positive electrode 22, the negative electrode 24, and the separator 26 are laminated, and has, for example, a flattened shape.

There is no particular limitation for the width of the body 20a, and it may be 10 cm or more, 20 cm or more, or 30 cm or more. The width of the body 20a may be 50 cm or less, or may be 40 cm or less. As used herein, the term “width of the body 20a” refers to the length of the body 20a in a direction along a winding axis WL of the electrode assembly 20.

As shown in FIGS. 1, 2, and 5, the electrode assembly 20 is placed inside the exterior casing 12 with the winding axis WL oriented parallel to the width direction Y. In this embodiment, the electrode assembly 20 is placed inside the exterior casing 12 with the winding axis WL oriented parallel to the bottom surface 12a and perpendicular to the second side surface 12c. The end faces of the electrode assembly 20 in the direction along the winding axis WL both face the corresponding second side surfaces 12c of the exterior casing 12. For the sake of clarity, the end face of the electrode assembly 20 (the body 20a) facing the second side surface 12c in the side close to the positive electrode current collector 50 (the left side in the width direction Y in FIGS. 2 and 4) is herein referred to as a “first end face 201”. The end face of the electrode assembly 20 (the body 20a) facing the second side surface 12c in the side close to the negative electrode current collector 60 (the right side in the width direction Y in FIGS. 2 and 4) is referred to as a “second end face 202”.

The positive electrode 22 comprises a long strip-shaped positive electrode current collector foil 22c (e.g., aluminum foil) and a positive electrode active material layer 22a bonded to at least one surface of the positive electrode current collector foil 22c. Although not particularly limited to this, a protective layer 22p may be provided on one side edge portion of the positive electrode 22 in the width direction Y, if desired. It is noted that any materials which can be used for this kind of secondary batteries may be used for materials of the positive electrode active material layer 22a and the protective layer 22p without any particular limitations.

Positive electrode tabs 22t are provided at one end (the left side end in FIG. 5) of the positive electrode current collector foil 22c in the width direction Y. The positive electrode tabs 22t each protrude toward one side in the width direction Y (the left side in FIG. 5). The positive electrode tabs 22t are provided at intervals (intermittently) along the longitudinal direction of the positive electrode 22. The positive electrode tabs 22t are portions of the positive electrode current collector foil 22c, more specifically exposed portions of the current collector foil in which neither the positive electrode active material layer 22a nor the protective layer 22p of the positive electrode current collector foil 22c is formed. In this embodiment, the positive electrode tabs 22t protrude toward the width direction Y relative to the separator 26. The positive electrode tabs 22t are stacked at one end in the width direction Y (the left side end in FIG. 5), forming the positive electrode tab group 23 (see FIGS. 2 to 4).

The negative electrode 24 comprises a long strip-shaped negative electrode current collector foil 24c (e.g., copper foil) and a negative electrode active material layer 24a bonded to at least one surface of the negative electrode current collector foil 24c. It is noted that any materials which can be used for this kind of secondary batteries may be used for materials of the negative electrode active material layer 24a without any particular limitations.

Negative electrode tabs 24t are provided at one end (the right side end in FIG. 5) of the negative electrode current collector foil 24c in the width direction Y. The negative electrode tabs 24t protrude toward one side in the width direction Y (the right side in FIG. 5). The negative electrode tabs 24t are provided at intervals (intermittently) along the longitudinal direction of the negative electrode 24. The negative electrode tabs 24t are portions of the negative electrode current collector foil 24c, more specifically exposed portions of the current collector foil in which the negative electrode active material layer 24a of the negative electrode current collector foil 24c is not formed. In this embodiment, the negative electrode tabs 24t protrude toward the width direction Y relative to the separator 26. The negative electrode tabs 24t are stacked at one end in the width direction Y (the right side end in FIG. 5), forming the negative electrode tab group 25 (see FIGS. 2 to 4).

The separator 26 insulates the positive electrode active material layer 22a of the positive electrode 22 from the negative electrode active material layer 24a of the negative electrode 24. The separator 26 forms the outer surface of electrode assembly 20a. The separator 26 may be, for example, a porous resin sheet made of a polyolefin resin such as polyethylene (PE) or polypropylene (PP).

As shown in FIGS. 1 to 3, the positive electrode terminal 30 and the negative electrode terminal 40 are mounted on the sealing plate 14. In this embodiment, the positive electrode terminal 30 is arranged at one end (the left side end in FIGS. 1 to 3) of the sealing plate 14 in the long-side direction Y. In this embodiment, the negative electrode terminal 40 is arranged at the other end (the right side end in FIGS. 1 to 3) of the sealing plate 14 in the long-side direction Y. The positive electrode terminal 30 or the negative electrode terminal 40 is an example of a “second electrically conductive member” in the energy storage device and the method of manufacturing the energy storage device as disclosed herein. Therefore, in the present specification, the positive electrode terminal 30 and/or the negative electrode terminal 40 may be alternatively read as the “second electrically conductive member”, when appropriate.

As shown in FIG. 2, the positive electrode terminal 30 is electrically connected to the positive electrode 22 (see FIG. 5) of the electrode assembly 20 via the positive electrode current collector 50 inside the exterior casing 12. The positive electrode terminal 30 is drawn out of the inside of the sealing plate 14 to the outside of the sealing plate 14 through the terminal mounting hole 18. The positive electrode terminal 30 is insulated from the sealing plate 14 by a first insulating member 71 and a second insulating member 72. The positive electrode terminal 30 is preferably made of, for example, aluminum or an aluminum alloy. An external electrically conductive member 35 is fixed on the positive electrode terminal 30. The positive electrode terminal 30 is joined to the external electrically conductive member 35.

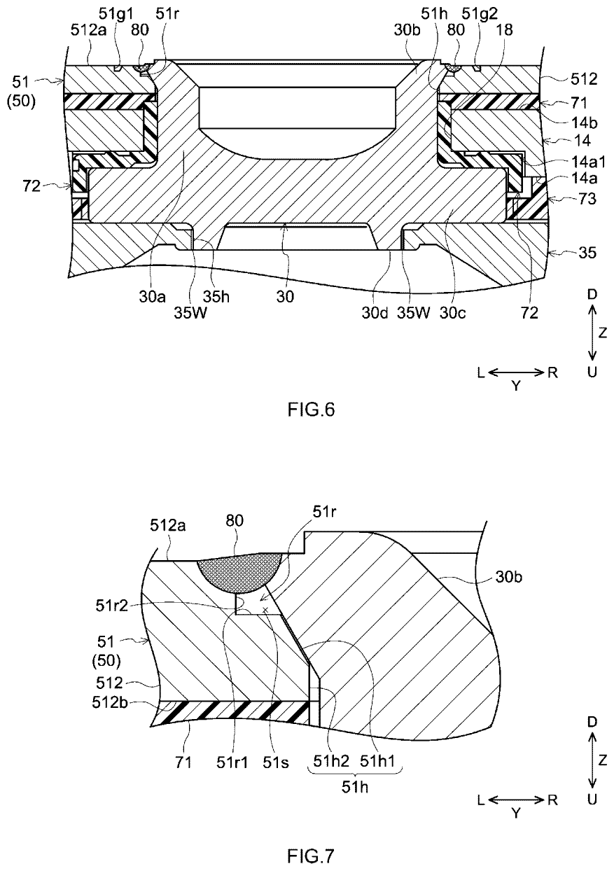

FIG. 6 shows a partially enlarged cross-sectional view of the vicinity of the positive electrode terminal 30 shown in FIG. 2. FIG. 6 schematically shows a cross-sectional structure along the thickness direction of the sealing plate 14 in the vicinity of the positive electrode terminal 30 in FIG. 2. For the sake of clarity, the upper side in FIG. 6 shows a structure of the sealing plate 14 in the side of the electrode assembly 20, and the lower side shows an outer structure of the sealing plate 14 (the same applies to FIGS. 7 and 9). As shown in FIG. 6, the positive electrode terminal 30 comprises a connection portion 30a, a riveted portion 30b, a flange portion 30c, and a protruding portion 30d.

The connection portion 30a is cylindrical in this case. As shown in FIG. 6, the connection portion 30a extends from the flange portion 30c and is inserted into the terminal mounting hole 18 of the case 10 and a through hole 51h of the positive electrode current collector 50. The outer diameter of the connection portion 30a is smaller than both of the diameter of the terminal mounting hole 18 and the diameter of the through hole 51h. The tip of the connection portion 30a is riveted onto the edge of the through hole 51h. This ensures the electrical connection between the positive electrode terminal 30 and the positive electrode current collector 50.

Here, the riveted portion 30b is provided at an end of the connection portion 30a. In this embodiment, the riveted portion 30b is a portion riveted onto the edge of the through hole 51h in the positive electrode current collector 50. Therefore, the diameter of the riveted portion 30b is larger than that of the connection portion 30a. In this embodiment, the riveted portion 30b is provided at an end of the connection portion 30a (in this case, an end opposite to the flange portion 30c). As shown in FIG. 6, the riveted portion 30b has a welded portion 80. The welded portion 80 will be described below in detail.

The flange portion 30c is disc-shaped in this case. The diameter of the flange portion 30c is preferably larger than the inner diameter of the terminal mounting hole 18. As shown in FIG. 6, the connection portion 30a is provided on one surface of the flange portion 30c (a surface in the side of the sealing plate 14). The protruding portion 30d is provided on the other surface of the flange portion 30c (a surface in the side of the external electrically conductive member 35). The flange portion 30c is arranged along an outer surface 14a of the sealing plate 14. In this embodiment, the flange portion 30c is received in a recessed portion 14a1 provided on the outer surface 14a of the sealing plate 14.

The protruding portion 30d here is substantially annular in a plan view. As shown in FIG. 6, the protruding portion 30d protrudes from the flange portion 30c. The protruding portion 30d is inserted into the through hole 35h of the external electrically conductive member 35. The protruding portion 30d is joined to the inner wall of the through hole 35h (a junction 35W).

The external electrically conductive member 35 here is plate-shaped and has the through hole 35h. As shown in FIG. 6, the external electrically conductive member 35 is arranged along the outer surface 14a of the sealing plate 14. In this embodiment, the protruding portion 30d of the positive electrode terminal 30 is inserted into and joined to the inside of the through hole 35h, thereby electrically connecting the external electrically conductive member 35 and the positive electrode terminal 30. A busbar is to be joined to the external electrically conductive member 35 when assembling the energy storage module. The external electrically conductive member 35 is preferably made of, for example, aluminum or an aluminum alloy.

As shown in FIG. 2, the positive electrode current collector 50 electrically connects the positive electrode 22 and the positive electrode terminal 30 of the electrode assembly 20 inside the exterior casing 12. In this embodiment, a portion of the positive electrode current collector 50 is connected to the positive electrode terminal 30. A different portion of the positive electrode current collector 50 is connected to the positive electrode tab group 23 of the electrode assembly 20. The positive electrode current collector 50 is preferably made of, for example, aluminum or an aluminum alloy. The positive electrode current collector 50 and/or the negative electrode current collector 60 are an example of a “first electrically conductive member” in the energy storage device and the method of manufacturing the energy storage device as disclosed herein. Therefore, in the present specification, the positive electrode current collector 50 and/or the negative electrode current collector 60 may be alternatively read as the “first electrically conductive member”, when appropriate

As shown in FIG. 2, the positive electrode current collector 50 comprises a first current collector member 51 and a second current collector member 52. In this embodiment, the first current collector member 51 has an L-shaped cross section and comprises a first plate portion 511 and a second plate portion 512. The first plate portion 511 here is plate-shaped, and extends from the second plate portion 512 toward the bottom surface 12a of the exterior casing 12. The first plate section 511 is connected to the second current collector member 52. The second plate portion 512 here is plate-shaped. As shown in FIG. 6, the second plate portion 512 is arranged along the inner surface 14b of the sealing plate 14. The second plate portion 512 at the end in the side of the second side surface 12c (see FIG. 1) is connected to the first plate portion 511.

FIG. 7 shows a partially enlarged view of FIG. 6. FIG. 7 shows a partially enlarged view of the region in the vicinity of the riveted portion 30b in FIG. 6. As shown in FIGS. 6 and 7, the second plate portion 512 has a recessed portion 51r. The recessed portion 51r is a portion which is recessed from the first surface 512a of the second plate portion 512. The first surface 512a is a surface of the second plate portion 512 in the side of the bottom surface 12a of the exterior casing 12. As shown in FIG. 7, the through hole 51h is provided at a bottom surface 51r1 of the recessed portion 51r. In this embodiment, the diameter of the bottom surface 51r1 is larger than the diameter of the through hole 51h.

In the configuration as shown in FIG. 7, the inner wall of the through hole 51h includes a tapered portion 51h1 and a non-tapered portion 51h2. The tapered portion 51h1 is connected to the bottom surface 51r1 of the recessed portion 51r and is sloped from the bottom surface 51r1. In this embodiment, the tapered portion 51h1 is sloped from the bottom surface 51r1 to the non-tapered portion 51h2. The diameter of the tapered portion 51h1 gradually decreases toward the non-tapered section 51h2. The non-tapered section 51h2 is connected to the tapered portion 51h1 and extends to a second surface 512b. The second surface 512b is a surface of the second plate portion 512 opposite to the first surface 512a, and is, in this case, arranged in the side of the sealing plate 14. The diameter of the non-tapered section 51h2 remains constant from the boundary with the tapered section 51h1 to the second surface 512b.

In this embodiment, at least a portion of the riveted portion 30b is arranged within the recessed portion 51r. In the configuration as shown in FIG. 7, a gap 51s is present among the bottom surface 51r1 of the recessed portion 51r, a side surface 51r2 of the recessed portion 51r, and the riveted portion 30b. The gap 51s is located in the inner side relative to the welded portion 80 (in the side of the sealing plate 14 relative to the welded portion 80 in a cross-sectional view along the thickness direction of sealing plate 14 (see FIGS. 6 and 7)). The gap 51s may be ring-shaped in a plan view. The gap 51s is preferably present continuously around the riveted portion 30b in a plan view. Although not particularly limited to this, the cross-sectional area of the gap 51s in the direction perpendicular to the direction along which the connection portion 30a extends is, for example, 0.0005 mm² or more, and preferably 0.0015 mm² or more. In general, the cross-sectional area may be 0.01 mm² or less.

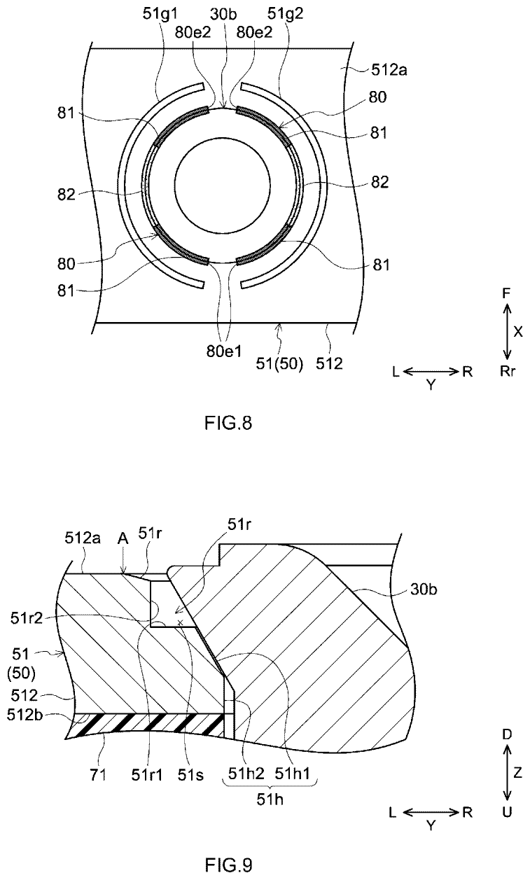

FIG. 8 shows a plan view of the vicinity of the riveted portion 30b. FIG. 8 shows a structure in the vicinity of the riveted portion 30b on the first surface 512a of the second plate portion 512. As shown in FIGS. 6 and 8, the second plate portion 512 has groove portions 51g1, 51g2 provided around the through hole 51h at the first surface 512a. In the configuration as shown in FIG. 8, the groove portions 51g1, 51g2 are provided around the riveted portion 30b. The groove portions 51g1, 51g2 are C-shaped in a plan view. Here, the riveted portion 30b is sandwiched between the groove portion 51g1 and the groove portion 51g2. In the configuration as shown in FIG. 8, the groove portion 51g1 and the groove portion 51g2 are not continuous. Therefore, a portion of the riveted portion 30b is not enclosed by either the groove portion 51g1 nor the groove portion 51g2. There is no particular limitation for the depths of the groove portions 51g1, 51g2, and they may be smaller than the depth of recessed portion 51r.

As shown in FIG. 8, the welded portion 80 comprises a first welded area 81 and a second welded area 82. The second welded area 82 is a region having a weld depth smaller than that of the first welded area 81. In this embodiment, the ratio (D1/D2) of a weld depth D1 of the first welded area 81 to a weld depth D2 of the second welded area 82 is, for example, 1.1 or more, preferably 1.2 or more, more preferably 1.5 or more, and most preferably 2 or more in view of achieving the effects of the presently disclosed technology. In contrary, (D1/D2) is generally 5 or less, for example 4.5 or less, preferably 4 or less, more preferably 3.5 or less, and most preferably 3 or less. It is noted that the weld depth D1 and the weld depth D2 are calculated by cutting the welded portion 80 along the thickness direction of the sealing plate 14, and observing the cross-section under a microscope (e.g., SEM) to measure the length of a molten portion.

As shown in FIG. 8, the welded portion 80 is provided along the circumferential direction of the riveted portion 30b. In this embodiment, the welded portion 80 is provided in a portion enclosed by the groove portion 51g1 or the groove portion 51g2 along the circumferential direction of the riveted portion 30b. Therefore, two replicates of the welded portion 80 are provided at the riveted portion 30b. Here, the two replicates of the welded portion 80 are not continuous.

In this embodiment, the first welded area 81 and the second welded area 82 are alternately provided along the circumferential direction of the riveted portion 30b at the welded portion 80. In the configuration as shown in FIG. 8, the first welded area 81, the second welded area 82, and the first welded area 81 are provided in this order from a first end 80e1 toward a second end 80e2 at the corresponding welded portion 80.

Although not particularly limited to these, for example, in view of better achieving the effects of the presently disclosed technology, in view of more effectively performing a welding step, in view of improving the conductivity between the positive electrode current collector 50 and the positive electrode terminal 30, and the like, the first welded area 81 and the second welded area 82 are preferably continuous at the welded portion 80. In this embodiment, the first welded area 81, the second welded area 82, and the first welded area 81 are continuous from the first end 80e1 toward the second end 80e2. Although not particularly limited to these, in view of similar perspectives, a length L1 of the first welded area 81 in a plan view is, for example, 2 mm or more, preferably 3 mm or more, and more preferably 5 mm or more. A length L2 of the second welded area 82 in a plan view is, for example, 2 mm or more, preferably 3 mm or more, and more preferably 5 mm or more. The upper limit of the length L1 and the upper limit of the length L2 may be selected to be, for example, but not particularly limited to, 20 mm. They may appropriately be selected based on factors such as the number of welded areas to be provided at the welded portion 80 and the size of the welded portion 80.

As shown in FIGS. 2 to 4, the second current collector member 52 extends toward the bottom surface 12a of the exterior casing 12. The second current collector member 52 has a first connection portion 52a and a second connection portion 52b. The first connection portion 52a is electrically connected to the first current collector member 51. In this embodiment, the first connection portion 52a is connected to the first current collector member 51 via a connection portion 521. The first connection portion 52a extends along the vertical direction Z. In this embodiment, the first connection portion 52a is arranged substantially perpendicular to the winding axis WL of the corresponding electrode assembly 20.

As shown in FIGS. 3 and 4, a fuse 52f is formed in the first connection portion 52a. The first connection portion 52a is designed such that the fuse 52f blows when a current of 1000 A or more (e.g., a short-circuit current) flows through the energy storage device 1. The cross-sectional area of the fuse 52f in the first connection portion 52a is smaller than the cross-sectional areas of the other portions except for the fuse 52f and the connection portion 521. The fuse 52f is, for example, an opening, a thin-walled portion, or the like. The first connection portion 52a is designed to blow when the current as described above flows by virtue of the presence of the fuse 52f.

The second connection portion 52b is joined to the positive electrode tab group 23. In this embodiment, the second connection portion 52b extends along the vertical direction Z. The second connection portion 52b is arranged substantially perpendicular to the winding axis WL of the corresponding electrode assembly 20. A surface connected to the positive electrode tabs 22t of the second connection portion 52b is arranged substantially parallel to the second side surface 12c of the exterior casing 12.

As shown in FIG. 2, the negative electrode terminal 40 is electrically connected to the negative electrode 24 (see FIG. 5) of the electrode assembly 20 via the negative electrode current collector 60 inside the exterior casing 12. The negative electrode terminal 40 is drawn out of the inside of the sealing plate 14 to the outside of the sealing plate 14 through the terminal mounting hole 19. The negative electrode terminal 40 is insulated from the sealing plate 14 by the first insulating member 71 and the second insulating member 72. The negative electrode terminal 40 is preferably made of, for example, copper or a copper alloy. An external electrically conductive member 45 (made of copper or a copper alloy) is fixed on the negative electrode terminal 40. The negative electrode terminal 40 is joined to the external electrically conductive member 45. The structure of the negative electrode terminal 40, its connection to the negative electrode current collector 60, and the like may be similar to the structure of the positive electrode terminal 30, its connection to the positive electrode current collector 50, and the like as described above. Therefore, descriptions of them are omitted here.

As shown in FIG. 2, the negative electrode current collector 60 electrically connects the negative electrode 24 and the negative electrode terminal 40 of the electrode assembly 20 inside the exterior casing 12. In this embodiment, a portion of the negative electrode current collector 60 is connected to the negative electrode terminal 40. A different portion of the negative electrode current collector 60 is connected to the negative electrode tab group 25 of the electrode assembly 20. The negative electrode current collector 60 is preferably made of, for example, copper or a copper alloy. The structure of the negative electrode current collector 60, its connection to the negative electrode tab group 25, and the like may be similar to the structure of the positive electrode current collector 50, its connection to the positive electrode tab group 23, and the like as described above. Therefore, descriptions of them are omitted here. It is noted that in FIG. 4, the numeral “621” represents a connection portion, the numeral “62a” represents a first connection portion, the numeral “62b” represents a second connection portion, and the numeral “62f” represents a fuse.

The various insulating members include, for example, the electrode assembly holder 29, the first insulating member 71, the second insulating member 72, and a third insulating member 73, as described above (see FIGS. 2 and 6). As shown in FIG. 2, the first insulating member 71 at one occurrence is arranged between the positive electrode current collector 50 and the sealing plate 14, and in another occurrence between the negative electrode current collector 60 and the sealing plate 14. The first insulating member 71 may, for example, comprise a portion which insulates the electrode assembly 20 from the sealing plate 14 (see FIG. 2). The second insulating member 72 at one occurrence is arranged between the positive electrode terminal 30 and the sealing plate 14, and at another occurrence between the negative electrode terminal 40 and the sealing plate 14. The third insulating member 73 at one occurrence is arranged between the external electrically conductive member 35 and the sealing plate 14, and at another occurrence between the external electrically conductive member 45 and the sealing plate 14. The constituent materials of the first insulating member 71, the second insulating member 72, and the third insulating member 73 may be, for example, the same as those of insulating members used for similar applications in this kind of energy storage devices.

As an electrolyte, any electrolytes used for this kind of energy storage devices may be used without any particular limitations.

The energy storage device 1 can be used for various applications, but it is particularly suitable for use as a power source (drive power supply) for a motor installed in a vehicle such as a passenger car, a truck, and the like. There is no particular limitation for the kind of vehicles, and they include, for example, plug-in hybrid electric vehicles (PHEVs), hybrid electric vehicles (HEVs), battery electric vehicles (BEVs), and the like. The energy storage device 1 may be used as, for example, a single cell unit to be included in an energy storage module.

A method of manufacturing the energy storage device 1 comprises, for example, a preparation step, an arrangement step, an insertion step, a riveting step, and a welding step. The method of manufacturing the energy storage device 1 will be described below with reference to the drawings as needed.

At the preparation step, the positive electrode current collector 50 having the through hole 51h, which is to be electrically connected to the positive electrode 22 or the negative electrode 24 of the electrode assembly 20, and the positive electrode terminal 30 having the connection portion 30a, which is to be electrically connected to the positive electrode current collector 50 are prepared. In addition, the sealing plate 14, the first insulating member 71, and the second insulating member 72 may be prepared at the preparation step.

At the arrangement step, the members prepared in the preparation step are arranged in their designated positions. At the arrangement step, for example, the first insulating member 71 and the second insulating member 72 are first attached to the sealing plate 14. Then, the second plate portion 512 of the positive electrode current collector 50 is aligned to the first insulating member 71. It is noted that there is no particular limitation for the order of such arrangements, and it may be altered as needed. According to other embodiments, the sealing plate 14 having some of the members other than the positive electrode terminal 30 already attached may be prepared at the preparation step. In this case, members which have not been yet attached in their designated positions at the preparation step may be appropriately arranged at the arrangement step. Alternatively, the arrangement step may be omitted.

At the insertion step, the connection portion 30a of the positive electrode terminal 30 is inserted into the through hole 51h of the positive electrode current collector 50. According to this embodiment, at the insertion step, the flange portion 30c of the positive electrode terminal 30 is arranged in the side of the outer surface 14a of the sealing plate 14, and the connection portion 30a is inserted into the through hole 51h of the positive electrode current collector 50 such that the connection portion 30a protrudes from the side of the inner surface 14b of the sealing plate 14.

At the riveting step, the end of the connection portion 30a is riveted onto the edge of the through hole 51h of the positive electrode current collector 50 to form the riveted portion 30b. At the riveting step, any riveting process (riveting) which can be used in a method of manufacturing this kind of energy storage devices can be used without particular limitations.

FIG. 9 shows a cross-sectional view of the vicinity of the riveted portion 30b after the riveting step. FIG. 9 schematically shows the positional relationship among the riveted portion 30b, the recessed portion 51r, and the through hole 51h of the positive electrode current collector 50 after the riveting step. As shown in FIG. 9, after the riveting step, the gap 51s is formed among the bottom surface 51r1 of the recessed portion 51r, the side surface 51r2 of the recessed portion 51r, and the riveted portion 30b.

At the welding step, the riveted portion 30b and the positive electrode current collector 50 are welded by irradiation with an energy beam. At the welding step, the irradiation with the energy beam is performed such that a gap (in this case, the gap 51s) between the positive electrode current collector 50 and the positive electrode terminal 30 is present in the inner side relative to a portion which is irradiated with the energy beam. In the configuration as shown in FIG. 9, the irradiation with the energy beam is performed along the edge of the recessed portion 51r in the positive electrode current collector 50 (an arrow A). This allows the riveted portion 30b and the positive electrode current collector 50 to be welded while leaving the gap 51s in the inner side relative to a portion where is irradiated with energy (in the side of the sealing plate 14 relative to the welded portion 80 in a plan view along the thickness direction of the sealing plate 14 (see FIGS. 6 and 7)).

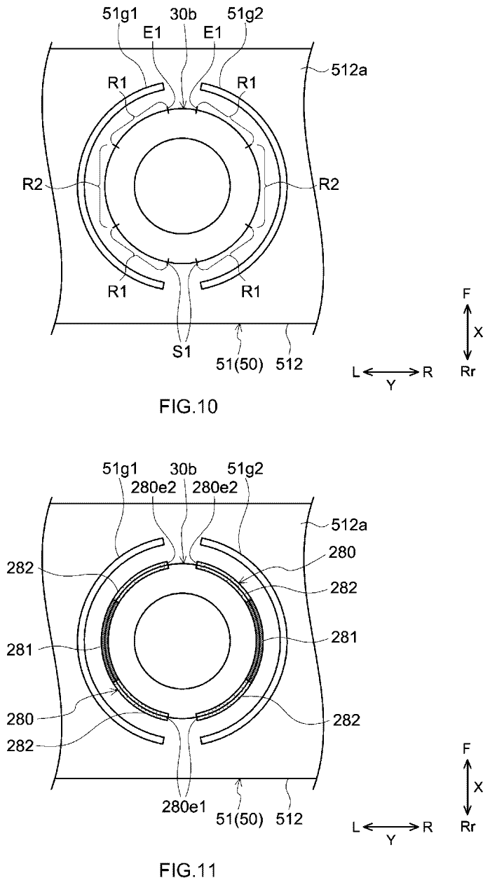

FIG. 10 shows a plan view of the vicinity of the riveted portion 30b. FIG. 10 shows a structure in the vicinity of the riveted portion 30b before performing the welding step in a plane as viewed from the side of the first surface 512a of the second plate portion 512 of the positive electrode current collector 50. The welding step comprises a first welding step and a second welding step. Here, the first welding step is a step of irradiating a first region R1 with an energy beam to form the first welded area 81 (see FIGS. 8 and 10). Here, the second welding step is a step of irradiating a second region R2 with an energy beam to form the second welded area 82 (see FIGS. 8 and 10). Although not particularly limited to this, the irradiation dose of the energy beam in the second welding step may be smaller than that of the energy beam irradiated in the first welding step. The irradiation dose of the energy beam at each step can be appropriately selected according to, for example, the desired weld depths of the first welded area 81 and the second welded area 82.

According to this embodiment, in the welding step, the first welding step and the second welding step are performed alternately to alternately provide the first welded area 81 and the second welded area 82 in the circumferential direction of the riveted portion 30b. In the configuration as shown in FIG. 10, the first welding step is performed on the first region R1 including a welding start point S1, from the welding start point S1 toward and end point E1. After the first welding step, the second welding step is performed on the second region R2 adjacent to the first region R1. After the second welding step, the first welding step is performed on the first region R1 including the end point E1, which is adjacent to the second region R2. This results in the formation of the first welded area 81 and the second welded area 82 as shown in FIG. 8. In this embodiment, the welding start point S1 corresponds to the first end 80e1 of the welded portion 80 (see FIGS. 8 and 10). The end point E1 corresponds to the second end 80e2 of the welded portion 80 (see FIGS. 8 and 10).

Energy such as, for example, light energy, thermal energy, and electron energy are preferably used for the irradiation with an energy beam used in the welding step. The welding step is preferably performed using, for example, laser welding. Among others, the welding step is preferably performed using continuous wave laser. Although not particularly limited to this, green laser may be preferably used in this embodiment.

Similarly, the preparation step, the arrangement step, the insertion step, and the welding step are performed on the side of the negative electrode.

After the welding step, for example, the electrode assembly 20 is attached to the structure obtained from the welding step. The electrode assembly 20 may be produced by a conventionally known method. In this embodiment, the second current collector member 52 of the positive electrode current collector 50 is attached to the positive electrode tab group 23 of the electrode assembly 20, and the second current collector member 62 of the negative electrode current collector 60 is attached to the negative electrode tab group 25. Then, the second current collector members 52, 62 attached to the electrode assembly 20 are attached to the first current collector members 51, 61 of the same electrode in the structure obtained from the welding step. Then, the electrode assembly 20 is housed in the electrode assembly holder 29. Then, the electrode assembly 20 covered by the electrode assembly holder 29 is housed in the exterior casing 12. While keeping this state, the sealing plate 14 is aligned with the opening 12h of the exterior casing 12, which are then welded to close the exterior casing 12.

After closing the exterior casing 12, an electrolyte is injected into the battery case 10 through the injection hole 15 using a conventionally known method. After injecting the electrolyte, the injection hole 15 is sealed with a sealing member 16. Then, while keeping a state where the injection hole 15 is sealed with the sealing member 16, laser welding or the like is performed to seal the injection hole 15. After sealing the injection hole 15, for example, initial charging and aging treatment can be performed under predetermined conditions to obtain a workable energy storage device 1.

As described above, the method of manufacturing the energy storage device 1 comprises a preparation step, an insertion step, a riveting step, and a welding step. At the preparation step, the positive electrode current collector 50 (first electrically conductive member) having the through hole 51h, which is to be electrically connected to the positive electrode 22 of the electrode assembly 20, and the positive electrode terminal 30 (second electrically conductive member) having the connection portion 30a, which is to be electrically connected to the positive electrode current collector 50 are prepared. At the insertion step, the connection portion 30a of the positive electrode terminal 30 is inserted into the through hole 51h of the positive electrode current collector 50. At the riveting step, the end of the connection portion 30a is riveted onto the edge of the through hole 51h of the positive electrode current collector 50 to form the riveted portion 30b. At the welding step, the riveted portion 30b and the positive electrode current collector 50 are welded by irradiation with an energy beam. At the welding step, the irradiation with the energy beam is performed such that the gap 51s between the positive electrode current collector 50 and the positive electrode terminal 30 is present in the inner side relative to a portion which is irradiated with the energy beam. The welding step comprises the first welding step and the second welding step. In the first welding step, the first region R1 is irradiated with an energy beam to form the first welded area 81. At the second welding step, the second region R2 is irradiated with an energy beam to form the second welded area 82 having a weld depth smaller than that of the first welded area 81.

In other words, in the method of manufacturing the energy storage device 1, the riveted portion 30b and the positive electrode current collector 50 are welded while the gap 51s is maintained between the positive electrode current collector 50 and the positive electrode terminal 30. This can allow gases, fumes, and the like generated during welding to be discharged to the outside through the gap 51s while performing welding. Therefore, the formation of blowholes can be suppressed in the welded portion 80. This, in turn, enables further improvement in the quality of welding between the positive electrode current collector 50 and the positive electrode terminal 30. Further, the welding step comprises a first welding step, and a second welding step of providing the second welded area 82. At the first welding step, the gap 51s remaining in the first welded area can be made smaller by providing the first welded area 81 having a relatively large weld depth. Therefore, the conductivity between the positive electrode current collector 50 and the positive electrode terminal 30 can be enhanced by performing the first welding step. At the second welding step, the second welded area 82 having a relatively small weld depth is provided. This can reduce the amounts of gases, fumes, and the like generated. In addition to this, welding can be performed while leaving a larger gap 51s. This enables more efficient discharge of gases, fumes, and the like, improving the quality of welding between the positive electrode current collector 50 and the positive electrode terminal 30.

The energy storage device 1 manufactured by performing the manufacturing method described above comprises the electrode assembly 20 including the positive electrode 22 and the negative electrode 24, the positive electrode current collector 50 (first electrically conductive member) electrically connected to the positive electrode 22, and the positive electrode terminal 30 (second electrically conductive member) electrically connected to the positive electrode current collector 50. The positive electrode current collector 50 includes the through hole 51h. The positive electrode terminal 30 includes the connection portion 30a and the riveted portion 30b. The connection portion 30a is inserted into the through hole 51h. The riveted portion 30b is provided at the end of the connection portion 30a, and is riveted onto the edge of the through hole 51h of the positive electrode current collector 50. The welded portion 80 where the positive electrode current collector 50 and the positive electrode terminal 30 are welded is provided in the riveted portion 30b. The gap 51s is present between the positive electrode current collector 50 and the positive electrode terminal 30 in the inner side relative to the welded portion 80. The welded portion 80 provided in the riveted portion 30b includes the first welded area 81, and the second welded area 82 having a weld depth smaller than that of the first welded area 81.

In the energy storage device 1, the gap 51s is present between the positive electrode current collector 50 and the positive electrode terminal 30 in the welded portion 80 between the positive electrode current collector 50 and the positive electrode terminal 30. The welded portion 80 includes the first welded area 81 having a relatively large weld depth and the second welded area 82 having a relatively small weld depth. This enables the gap 51s to be relatively smaller in the first welded area 81, thereby enhancing the conductivity between the positive electrode current collector 50 and the positive electrode terminal 30. In forming the second welded area 82, the reduced weld depth of the second welded area 82 can reduce the generation of gases, fumes, and the like during welding. In addition to this, the relatively large gap 51s can facilitate the discharge of gases, fumes, and the like. Therefore, the generation of blowholes can be suppressed in the first welded area 81 and the second welded area 82, leading to a further improved quality of welding at the welded portion 80 between the positive electrode current collector 50 and the positive electrode terminal 30.

The energy storage device 1 may further comprise a case 10 for housing the electrode assembly 20. The case 10 may have the terminal mounting hole 18. The positive electrode terminal 30 may be inserted into the terminal mounting hole 18. This configuration can enhance the electrical connectivity among the electrode assembly 20, the positive electrode current collector 50, and the positive electrode terminal 30.

The positive electrode current collector 50 may have the recessed portion 51r. The through hole 51h may be provided at the bottom surface 51r1 of the recessed portion 51r. At least a portion of the riveted portion 30b may be arranged within the recessed portion 51r. The gap 51s may be located among the bottom surface 51r1 of the recessed portion 51r, the side surface 51r2 of the recessed portion 51r, and the riveted portion 30b. This enables the gap 51s to be more reliably maintained at the welded portion 80, thereby better achieving the effects of the presently disclosed technology.

The tapered portion 51h1 which is connected to the bottom surface 51r1 of the recessed portion 51r and sloped from the bottom surface 51r1 may be provided on the inner wall of the through hole 51h. This can easily secure the mechanical bonding strength between the riveted portion 30b and the edge of the through hole 51h.

On a surface (first surface 512a) of the positive electrode current collector 50 where the riveted portion 30b is provided, the groove portions 51g1, 51g2 may be provided around the riveted portion 30b. This can suppress a phenomenon (sagging) in which a metal material around the riveted portion 30b (in this embodiment, the edge of the recessed portion 51r, the side surface 51r2, and the like) moves outward from the riveted portion due to welding.

At the welding step, the first welding step and the second welding step are performed alternately to alternately provide the first welded area 81 and the second welded area 82 in the circumferential direction of the riveted portion 30b. This enables the provision of a region to be welded while leaving a smaller gap 51s and a region to be welded while leaving a larger gap 51s. Therefore, gases, fumes, and the like due to welding can be efficiently discharged while reducing the generation of gases, fumes, and the like due to welding. This can enhance the quality of welding, and also allow for securing an appropriate weld depth and weld range.

At the welding step, the first welding step may be performed on the first region R1 including a welding start point S1, and the second welding step may be performed after the first welding step. At the beginning of welding, there is no welded portion around the first region R1 including the welding start point S1. Therefore, even if gases, fumes, and the like are generated during welding, a path (gap 51s) for discharging them is secured. At the second welding step, welding is performed so as to give a smaller weld depth. Therefore, the generation of gases, fumes, and the like can be reduced. This can more efficiently suppress the generation of blowholes.

Although not particularly limited to this, the first welding step may be performed after the second welding step in the aspect as described above. This enables, for example, the area of the first welded area 81 in the welded portion 80 to be increased. This, in turn, enables further improvement in the conductivity between the positive electrode current collector 50 and the positive electrode terminal 30.

The embodiments of the presently disclosed technology are described above, but these embodiments are merely illustrative and shall not limit the scope of the claims. The technology described in the claims includes various modifications and alterations made to the embodiments illustrated above.

FIG. 11 shows a plan view of the vicinity of the riveted portion 30b. FIG. 11 shows a structure in the vicinity of the riveted portion 30b at the first surface 512a of the second plate portion 512 according to another embodiment. In a configuration as shown in FIG. 11, welded portions 280 where the positive electrode current collector 50 and the positive electrode terminal 30 are welded together are provided in the riveted portion 30b. At each of the welded portions 280, a second welded area 282, a first welded area 281, and a second welded area 282 are provided in this order from a first end 280e1 toward a second end 280e2.

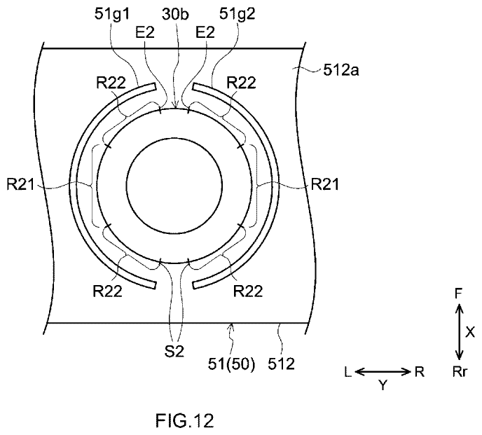

FIG. 12 shows a plan view of the vicinity of the riveted portion 30b. FIG. 12 shows a structure in the vicinity of the riveted portion 30b before the welding step according to another embodiment in a plane as viewed from the side of the first surface 512a of the second plate portion 512 of the positive electrode current collector 50. In the configuration as shown in FIG. 12, the second welding step is performed on a second region R22 including a welding start point S2 from the welding start point S2 toward an end point E2. After the second welding step, the first welding step is performed on a first region R21 adjacent to the second region R22. After the first welding step, the first welding step is performed on the second region R22 including the end point E2 and adjacent to the first region R21. By this, the first welded area 281 and the second welded area 282 are provided as shown in FIG. 11. In this embodiment, the welding start point S2 corresponds to the first end 280e1 of the welded portion 280 (see FIGS. 11 and 12). The end point E2 corresponds to the second end 280e2 of the welded portion 280 (see FIGS. 11 and 12).

As described above, at the welding step in the manufacturing method as disclosed in this section, the second welding step is first performed on the second region R22 including the welding start point S2, and the first welding step may be then performed after the second welding step. At the beginning of welding, there is no welded portion around the second region R22 including the welding start point S2. Therefore, even if gases, fumes, and the like are generated during the second welding step, they can be easily discharged. Subsequently in the first welding step, more gases, fumes, and the like may be generated as compared to the second welding step. However, the second welding step can suppress reduction of gap 51s caused by welding, and thus the gases, fumes, and the like generated during the first welding step can be efficiently discharged. This can more efficiently suppress the generation of blowholes.

Although not particularly limited to this, the second welding step may further be performed after the first welding step in the aspect as described above. This enables the welding of the positive electrode current collector 50 and the positive electrode terminal 30 under conditions where, for example, the generation of gases, fumes, and the like is reduced and a larger gap 51s for discharging them is secured.

It is noted that there is no particular limitation for the number, length, and arrangement of the first welded area and the second welded area included in the welded portion, and they may be appropriately selected as long as the effects of the presently disclosed technology can be achieved.

The technology disclosed herein may have the aspects described in the following items.

### Item 1

An energy storage device comprising:
an electrode assembly including a positive electrode and a negative electrode,
a first electrically conductive member electrically connected to the positive electrode or the negative electrode, and
a second electrically conductive member electrically connected to the first electrically conductive member,
wherein
   the first electrically conductive member includes a through hole;
   the second electrically conductive member includes
      a connection portion inserted into the through hole and
      a riveted portion provided at an end of the connection portion and riveted onto an edge of the through hole of the first electrically conductive member;
   the riveted portion includes a welded portion where the first electrically conductive member and the second electrically conductive member are welded together;
   a gap is provided between the first electrically conductive member and the second electrically conductive member in an inner side relative to the welded portion; and
   the welded portion provided at the riveted portion includes a first welded area and a second welded area having a weld depth smaller than that of the first welded area.

### Item 2

The energy storage device according to item 1,
further comprising a case for housing the electrode assembly, wherein
the case has a terminal mounting hole; and
the second electrically conductive member is a terminal inserted into the terminal mounting hole.

### Item 3

The energy storage device according to item 1 or 2, wherein
the first electrically conductive member has a recessed portion;
the through hole is provided at a bottom surface of the recessed portion;
at least a portion of the riveted portion is arranged within the recessed portion;
the gap is located among the bottom surface of the recessed portion, a side surface of the recessed portion, and the riveted portion.

### Item 4

The energy storage device according to item 3, wherein
a tapered portion is provided on an inner wall of the through hole, the tapered portion being connected to the bottom surface of the recessed portion and sloped from the bottom surface.

### Item 5

The energy storage device according to any one of items 1 to 4, wherein
a groove portion is provided around the riveted portion on a surface of the first electrically conductive member where the riveted portion is provided.

### Item 6

The energy storage device according to any one of items 1 to 5, wherein
the first welded area and the second welded area are alternately provided in a circumferential direction of the riveted portion.

### Item 7

A method of manufacturing an energy storage device comprising an electrode assembly including a positive electrode and a negative electrode, the method comprising:
a preparation step of preparing a first electrically conductive member having a through hole, which is to be electrically connected to the positive electrode or the negative electrode of the electrode assembly, and a second electrically conductive member having a connection portion which is to be electrically connected to the first electrically conductive member;
an insertion step of inserting the connection portion of the second electrically conductive member into the through hole of the first electrically conductive member;
a riveting step of riveting an end of the connection portion to an edge of the through hole of the first electrically conductive member to form a riveted portion; and
a welding step of welding the riveted portion and the first electrically conductive member by irradiation with an energy beam,
wherein
   at the welding step, the irradiation with the energy beam is performed under the condition that a gap between the first electrically conductive member and the second electrically conductive member is present in an inner side relative to a portion which is irradiated with the energy beam, and
   the welding step includes
      a first welding step of irradiating a first region with the energy beam to form a first welded area, and
      a second welding step of irradiating a second region with the energy beam to form a second welded area having a weld depth smaller than that of the first welded area.

### Item 8

The manufacturing method according to item 7, wherein
a case for housing the electrode assembly is further provided
the case has a terminal mounting hole; and
the second electrically conductive member is a terminal inserted into the terminal mounting hole.

### Item 9

The manufacturing method according to item 7 or 8, wherein
the first electrically conductive member has a recessed portion;
the through hole is provided at a bottom surface of the recessed portion;
the riveted portion is arranged within the recessed portion; and
the gap is located among the bottom surface of the recessed portion, a side surface of the recessed portion, and the riveted portion.

### Item 10

The manufacturing method according to item 9, wherein
a tapered portion is provided on an inner wall of the through hole, the tapered portion being connected to the bottom surface of the recessed portion and sloped from the bottom surface.

### Item 11

The manufacturing method according to any one of item 7 to 10, wherein
a groove portion is provided around the riveted portion on a surface of the first electrically conductive member where the riveted portion is provided.

### Item 12

The manufacturing method according to any one of item 7 to 11, wherein
at the welding step, the first welding step and the second welding step are performed alternately to alternately provide the first welded area and the second welded area in a circumferential direction of the riveted portion.

### Item 13

The manufacturing method according to any one of item 7 to 12, wherein
at the welding step, the first welding step is performed on the first region including a welding start point, and the second welding step is performed after the first welding step.

### Item 14

The manufacturing method according to any one of item 7 to 12, wherein
at the welding step, the second welding step is first performed on the second region including a welding start point, and the first welding step is then performed after the second welding step.

What is claimed is:

1. An energy storage device, comprising:
an electrode assembly including a positive electrode and a negative electrode,
a first electrically conductive member electrically connected to the positive electrode or the negative electrode, and
a second electrically conductive member electrically connected to the first electrically conductive member, wherein
the first electrically conductive member includes a through hole;
the second electrically conductive member includes
a connection portion inserted into the through hole, and
a riveted portion provided at an end of the connection portion and riveted onto an edge of the through hole of the first electrically conductive member;
the riveted portion includes a welded portion where the first electrically conductive member and the second electrically conductive member are welded together;
a gap is provided between the first electrically conductive member and the second electrically conductive member in an inner side relative to the welded portion; and
the welded portion provided at the riveted portion includes a first welded area and a second welded area having a weld depth smaller than that of the first welded area.

2. The energy storage device according to claim 1,
further comprising a case for housing the electrode assembly, wherein
the case has a terminal mounting hole; and
the second electrically conductive member is a terminal inserted into the terminal mounting hole.

3. The energy storage device according to claim 1, wherein
the first electrically conductive member has a recessed portion;
the through hole is provided at a bottom surface of the recessed portion;
at least a portion of the riveted portion is arranged within the recessed portion;
the gap is located among the bottom surface of the recessed portion, a side surface of the recessed portion, and the riveted portion.

4. The energy storage device according to claim 3, wherein
a tapered portion is provided on an inner wall of the through hole, the tapered portion being connected to the bottom surface of the recessed portion and sloped from the bottom surface.

5. The energy storage device according to claim 1, wherein
a groove portion is provided around the riveted portion on a surface of the first electrically conductive member where the riveted portion is provided.

6. The energy storage device according to claim 1, wherein
the first welded area and the second welded area are alternately provided in a circumferential direction of the riveted portion.

7. A method of manufacturing an energy storage device comprising an electrode assembly including a positive electrode and a negative electrode, the method comprising:
a preparation step of preparing a first electrically conductive member having a through hole, which is to be electrically connected to the positive electrode or the negative electrode of the electrode assembly, and a second electrically conductive member having a connection portion which is to be electrically connected to the first electrically conductive member;
an insertion step of inserting the connection portion of the second electrically conductive member into the through hole of the first electrically conductive member;
a riveting step of riveting an end of the connection portion to an edge of the through hole of the first electrically conductive member to form a riveted portion; and
a welding step of welding the riveted portion and the first electrically conductive member by irradiation with an energy beam,
wherein
at the welding step, the irradiation with the energy beam is performed under the condition that a gap between the first electrically conductive member and the second electrically conductive member is present in an inner side relative to a portion which is irradiated with the energy beam, and
the welding step includes
a first welding step of irradiating a first region with the energy beam to form a first welded area, and
a second welding step of irradiating a second region with the energy beam to form a second welded area having a weld depth smaller than that of the first welded area.

8. The manufacturing method according to claim 7, wherein
the energy storage device comprises a case for housing the electrode assembly;
the case has a terminal mounting hole; and
the second electrically conductive member is a terminal inserted into the terminal mounting hole.

9. The manufacturing method according to claim 7, wherein
the first electrically conductive member has a recessed portion;
the through hole is provided at a bottom surface of the recessed portion;
the riveted portion is arranged within the recessed portion; and
the gap is located among the bottom surface of the recessed portion, a side surface of the recessed portion, and the riveted portion.

10. The manufacturing method according to claim 9, wherein
a tapered portion is provided on an inner wall of the through hole, the tapered portion being connected to the bottom surface of the recessed portion and sloped from the bottom surface.

11. The manufacturing method according to claim 7, wherein
a groove portion is provided around the riveted portion on a surface of the first electrically conductive member where the riveted portion is provided.

12. The manufacturing method according to claim 7, wherein
at the welding step, the first welding step and the second welding step are performed alternately to alternately provide the first welded area and the second welded area in a circumferential direction of the riveted portion.

13. The manufacturing method according to claim 7, wherein
at the welding step, the first welding step is performed on the first region including a welding start point, and the second welding step is performed after the first welding step.

14. The manufacturing method according to claim 7, wherein
at the welding step, the second welding step is first performed on the second region including a welding start point, and the first welding step is then performed after the second welding step.
